(19) United States
(12) Patent Application Publication
(10) Pub. No.: US 2017/0021484 A1
(43) Pub. Date: Jan. 26, 2017

(54) INSERTION TOOL

(71) Applicant: NEWFREY LLC, New Britain, CT (US)

(72) Inventors: Jan Szewc, Roxbury, CT (US); Neil F. Baldino, Sandy Hook, CT (US)

(21) Appl. No.: 15/284,883

(22) Filed: Oct. 4, 2016

Related U.S. Application Data
(63) Continuation of application No. PCT/US2015/024498, filed on Apr. 6, 2015.
(60) Provisional application No. 62/046,600, filed on Sep. 5, 2014.

(51) Int. Cl. B25B 27/14

(52) U.S. Cl. CPC B25B 27/143

(57) ABSTRACT

An insertion tool is used to insert a threaded coil insert into a threaded opening of a support structure. The tool includes a rotatable mandrel body having an axial longitudinal passage and a projection slot. A plunger is disposed in the passage forward of a spring which urges the plunger forward. The plunger in turn urges a drive projection. A front end of the plunger includes an inclined surface that slidingly and inclinedly engages an inclined surface of the drive projection. The urging of the drive projection by the plunger along their respective inclined surfaces causes relative sliding movement of the drive projection so that the drive projection translates linearly through the projection slot in a direction perpendicular to the longitudinal passage.

### CROSS-REFERENCE TO RELATED APPLICATIONS

This application is a continuation of PCT/US2015/024498, filed Apr. 6, 2015 which claims priority from U.S. patent application Ser. No. 14/246,478, filed Apr. 7, 2014, and U.S. Provisional Patent application No. 62/046,600, filed Sep. 5, 2014, the disclosures of which are incorporated herein by reference in their entirety.

### BACKGROUND OF THE INVENTION

This invention relates to an insertion tool, and particularly relates to a power driven tool for inserting Tang-free helical coil inserts into tapped openings.

Helical coil inserts have been used for some time to revitalize worn or damaged threads of openings in support structures. Such inserts also have been used to provide a durable threaded opening in support structures which are composed of materials which may not be sufficiently durable to support long-term use of threads therein. The threads of the coil inserts will remain durable for a longer period, compared to the threads of the opening of the support structure, even though there may be frequent removal and reinsertion, or replacement, of threaded fasteners eventually mounted in threaded opening of the coil insert.

The helical coil inserts are typically made from a preformed metal wire, typically formed with a diamond shaped cross-section, which is wound to form a helical coil having successive convolutions. The helical coil is referred to herein as a “coil insert.” The coil insert is wound in such a manner that outer and inner threads are formed by sharp, generally “V” shaped portions on opposite sides of the diamond cross section on the outer and inner surfaces, respectively, of the insert.

The size of the outer threads of the coil insert are consistent with the size of the threads of the opening in the support structure. The size of the inner threads of the coil insert are consistent with the size of the threads typically formed on a portion of the outer surface of the threaded fastener, which is eventually threadedly mounted in coil insert.

In the past, one end of the coil insert was formed with a straight tang to extend diametrically across the immediately adjacent full convolution, and was used to drive the coil insert into the threaded opening of the support structure. In more recent times, the coil insert has not been formed with the tang, but has been formed with a drive notch on the inside of the last convolution near the end of the insert which serves as the facility to drive the insert into the threaded opening of the support structure.

In the past, the coil inserts have been assembled by use of a tool such as, for example, the tool disclosed in U.S. Pat. No. 4,528,737, which issued on Jul. 16, 1985. The tool of the '737 patent includes a rotatable rod having a cutout extending longitudinally through a portion thereof, but which is closed at opposite ends thereof, including a coil insertion end of the tool. The rod is formed with threads on the exterior thereof which begin inboard of the insertion end of the tool and extend toward the opposite end thereof. A longitudinal pawl is mounted pivotally in the cutout and is formed with a pair of lead ramps extending inboard from the insertion end of the pawl. The rod is also formed with a hook portion inboard of the lead ramps and is biased so that the ramps and the hook portion can protrude through a lateral aperture formed through the rod and in communication with the cutout.

In use of the tool of the '737 patent, the coil insert is threadedly assembled on the insertion end of the rod until the biased hook portion is located in the drive notch of the insert. At this juncture, the lead end of the coil insert and the hook portion are located somewhat rearward of the insertion end of the rod and the tool. A power driver is then used to rotate the rod and the pawl, as the insert and rod are inserted into the threaded opening of the support structure, whereby the hook portion drives the insert into the threaded opening.

For at least two reasons the prior art designs (including the '737 design) are less than ideal. First, because the hook of the prior art (e.g., '737) travels in a radially sweeping path toward the coil notch, it changes longitudinal position in the direction of pitch along its path. Because the drive notch of a coil is small, the change in position in the direction of pitch could significantly affect the alignment of the hook with the notch. Second, different amounts of sweep of the hook mean that the hook will have different orientations as it is positioned to engage notches. Therefore, as the hook contacts various coils during installation, such contact will be at different orientations and with different portions of the hook and therefore encourage uneven wear of the hook over time. Such wear may eventually compromises precision engagement between the tool's hook and the drive notch of the coil.

Thus, there is a need for an insertion tool which has a hook portion that extends to engagement with the coil drive notch via a linear motion to minimize the uncertainty of the hook-to-notch path and to maintain perfect alignment of the hook with the drive notch of the coil no matter the size or configuration of the coil. There is also a need to develop a tool that eliminates engagement of the hook with the coil at various orientations of the hook to minimize wear of the hook over time.

### SUMMARY OF THE INVENTION

The present disclosure describes an insertion tool for inserting a threaded insert within a threaded opening of a support structure. The tool has a rotatable mandrel having a mandrel insertion end and a driven end located at opposite ends of a longitudinal axis of the mandrel. The mandrel has a first passage formed in the mandrel along a directional axis that is generally perpendicular to the longitudinal axis. The first passage defines a projection slot at an end of the mandrel. In addition, the tool includes a drive projection that is confined to travel within the first passage along the directional axis. The drive projection includes a projection stop for limiting travel of the drive projection along the directional axis and a drive hook for engaging a threaded insert. The tool also includes a bias member that engages with the drive projection such that the bias member urges the drive projection to extend the drive hook proud of the projection slot. Furthermore, the projection stop engages a stop portion on the mandrel to limit travel of the drive projection within the first passage.

It is, therefore, an object of this invention to provide an insertion tool for inserting a threaded insert within a threaded opening of a support structure in an efficient and effective manner.

Other objects, features and advantages of the present invention will become more fully apparent from the following detailed description of the preferred embodiment, the appended claims and the accompanying drawings.

### BRIEF DESCRIPTION OF THE DRAWINGS

FIG. 1 is a sectional view showing a support structure with a threaded opening formed therein;

FIG. 2 is a sectional view showing the structure of a helical coil insert for assembly within the threaded opening of FIG. 1;

FIG. 3 is an end view of the helical coil insert of FIG. 2 showing a tang-less end of the insert with a drive notch formed therein;

FIG. 4 is a partial view taken within line 4 of FIG. 3 showing an enlargement of a drive end of the tang-free insert of FIG. 3, and showing in phantom a drive hook, in accordance with certain principals of the invention;

FIG. 5 is a sectional view showing an insertion tool for inserting the insert of FIG. 2 into the opening of FIG. 1 in accordance with certain principles of the invention;

FIG. 6 is a partial sectional view showing of a mandrel of the tool of FIG. 4 in accordance with certain principles of the invention;

FIG. 7 is a side view showing the mandrel of the tool of FIG. 4 in accordance with certain principles of the invention;

FIG. 8 is a partial side view of an insertion end of the mandrel of FIGS. 6 and 7 showing first and second slots and an insertion end opening of the mandrel in communication in accordance with certain principles of the invention;

FIG. 9 is a side view showing a blade and the drive hook of FIG. 4 in accordance with certain principles of the invention; and

FIG. 10 is an end view of the blade showing the profile of the drive hook formed on the insertion of the blade in accordance with certain principles of the invention;

FIG. 11 is a cross-sectional view of an alternative embodiment of the insertion tool of FIG. 5 for inserting the insert of FIG. 2 into the opening of FIG. 1 in accordance with certain principles of the invention;

FIG. 12A is a front perspective cross-sectional view of the embodiment of FIG. 11;

FIG. 12B is a cross-sectional view of the embodiment of FIG. 12A with no spacer;

FIG. 13 is a front perspective cross-sectional view of the front end of the embodiment of FIG. 11;

FIG. 14 is an enlarged cross-sectional side view of the front end of the embodiment of FIG. 11;

FIG. 15 is a front perspective cross-sectional view of the mandrel of the embodiment of FIG. 11;

FIG. 16 is an enlarged cross-sectional perspective view of the front end of the mandrel of the embodiment of FIG. 11;

FIG. 17 is a front perspective view of the plunger of the embodiment of FIG. 11;

FIG. 18A is a right front perspective view of the drive extension of the embodiment of FIG. 11;

FIG. 18B is a left front perspective view of the drive extension of the embodiment of FIG. 11;

FIG. 19 is a side cross-sectional view of a drive assembly of the present invention.

FIG. 20 is an enlarged side cross-sectional view of the insertion tool of the drive assembly of FIG. 19.

FIG. 21A is a perspective view of a clutch mechanism of the drive portion of the insertion tool of FIG. 20.

FIG. 21B is an enlarged cross-sectional perspective view of the clutch mechanism of FIG. 20.

FIG. 21C is an enlarged side view of the clutch mechanism of FIG. 20 showing an engaged clutch.

FIG. 21D is an enlarged side view of the clutch mechanism of FIG. 20 showing an engaged clutch slipping in forward direction.

FIG. 21E is an enlarged side view of the clutch mechanism of FIG. 20 showing a engaged clutch in reverse direction.

### DETAILED DESCRIPTION OF THE PREFERRED EMBODIMENT

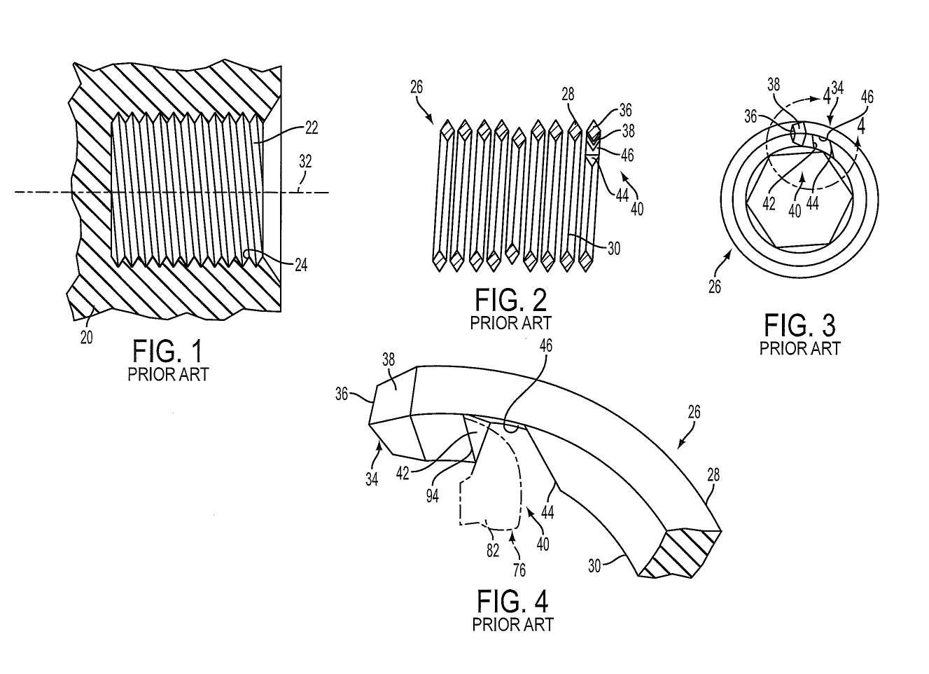

As shown in FIG. 1, a support structure 20 is formed with a threaded opening 22 having a plurality of threads 24 formed therein. Referring to FIG. 2, a helical coil insert 26 is typically made from a preformed metal wire, typically formed with a diamond cross section, which is wound to form a helical coil having successive convolutions. The coil insert 26 is wound in such a manner that outer threads 28 and inner threads 30 are formed by sharp, generally “V” shaped portions on opposite sides of the diamond cross section on the outer and inner surfaces, respectively, of the insert.

The size of the outer threads 28 of the coil insert 26 are consistent with the size of the threads 24 of the opening 22 in the support structure 20. The size of the inner threads 30 of the coil insert 26 are consistent with the size of the threads typically formed on a portion of the outer surface of a threaded fastener (not shown), which eventually is to be threadedly mounted in coil insert.

The coil insert 26 may be used for facilitating the effective reconstruction of a fastener-receiving threaded opening in the support structure 20. In the reconstruction process, the original opening in the support structure 20, as shown in FIG. 1, is bored to remove worn or damaged threads, whereby an oversize, smooth-walled passage is formed about an axis 32. The passage is then tapped to form the threaded opening 22 having the threads 24 of a prescribed size.

If the material from which the support structure 20 is formed is not of acceptable durable quality, the threaded opening 22, and threads 24, may be formed at the time plans are first made to use the support structure for receiving a threaded fastener.

Regardless of whether the coil insert 26 is used in a reconstruction process, or in the initial formation of a fastener-receiving opening, the opening 22 and the threads 24 are formed in the support structure 20 as shown in FIG. 1 in preparation for receipt of the durable coil insert 26.

Referring to FIGS. 3 and 4, the coil insert 26 is formed with a leading end 34 which includes a leading surface 36 and truncated sides 38. A drive slot 40 is formed in the underside of the leading end 34 just behind the truncated sides 38. The drive slot 40, in the preferred embodiment, is formed by two spaced interfacing walls 42 and 44 and a ceiling 46 by cutting away the radially inside half of the diamond cross section. In addition, the spaced walls 42 and 44 are sloped radially inward and rearward toward a trailing end of the coil insert 26.

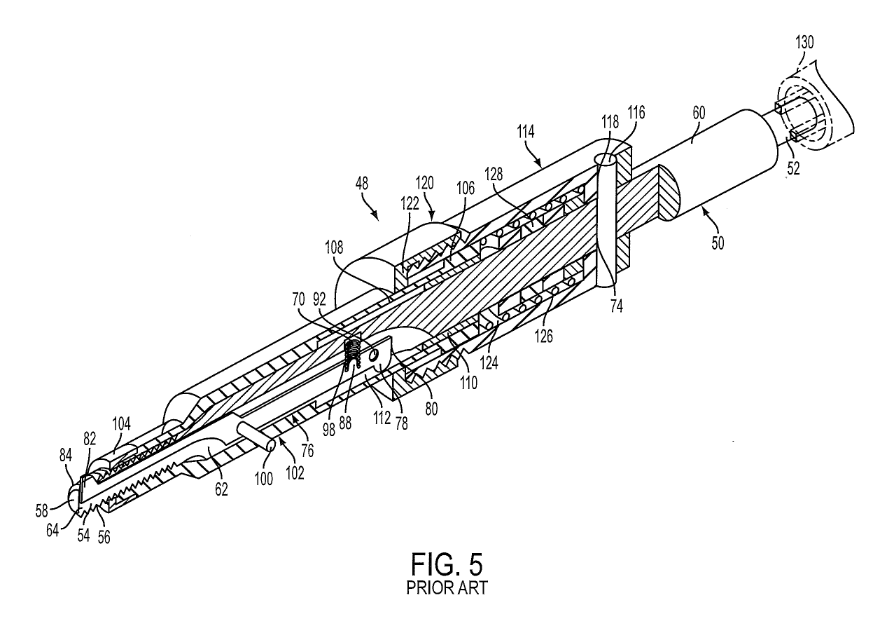

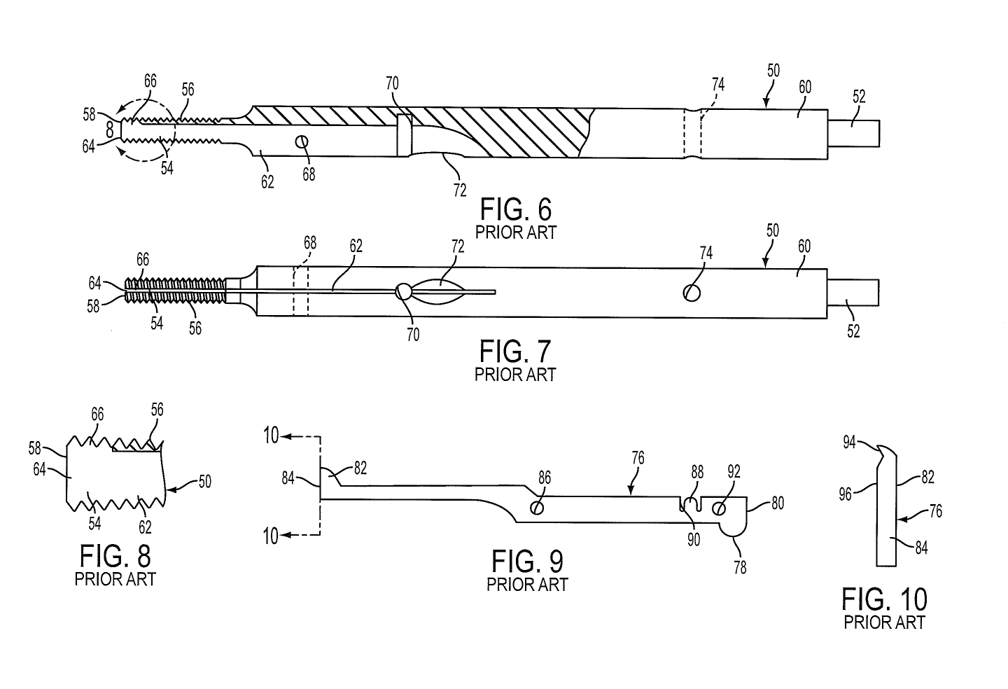

As shown in FIG. 5, an insertion tool 48 is used for inserting the coil insert 26 threadedly into the threaded opening 22 of the support structure 20. The tool 48 includes a rotatable mandrel 50, also shown in FIGS. 6 and 7, which is formed with a drive shank 52 at a trailing end thereof and a forward extension 54 at a mandrel insertion end thereof. The forward extension 54 of the mandrel 50 is formed with threads 56 externally thereof which are the same size as the inner threads 30 of the coil insert 26. The forward extension 54 is also formed with a forward end face 58 which is the forwardmost surface of the mandrel 50. An intermediate section 60 of the mandrel 50 extends between the drive shank 52 and the forward extension 54, and is formed generally with a circular cross section.

Referring to FIGS. 6, 7 and 8, the mandrel 50 is formed with a first slot 62 in a first side thereof which extends transaxially into the mandrel but does not extend to the opposite side thereof. A forward end opening or end slot 64 is formed in the forward end face 58 of the mandrel 50 and communicates with the first slot 62. A second slot 66 is formed in the forward extension 54 transaxially into the mandrel 50 in a second side, which is diametrically opposite the first side, and is in communication with the first slot 62 and the end opening 64. The first slot 62, the end opening 64 and the second slot 66 are formed with the same width.

As shown in FIGS. 6 and 7, the mandrel 50 is formed with a pivot pin opening 68 laterally on each side of the first slot 62 at a juncture near the axial middle of the first slot. A spring cavity 70 is formed in the mandrel 50 generally in the plane of the first slot 62 and rearward of the opening 68. The cavity 70 is open to the first side of the mandrel 50 as the first slot 62, and extends deeper into the mandrel than the first slot but does not extend through the mandrel. A concave section 72 is formed in the exterior surface of the mandrel 50 at the first side thereof and trails the exterior opening of the cavity 70. A body pin hole 74 is formed through the mandrel 50 near the shank 52 thereof.

As shown in FIGS. 5 and 9, a blade 76 is formed in a longitudinal direction and with a thickness slightly less than the width of the first slot 62 of the mandrel 50. A rounded nib 78 extends laterally in one direction from a trailing end 80 of the blade 76, and a drive extension 82 extends laterally in an opposite direction from a forward or insertion end face 84 of the blade. A pivot pin opening 86 is formed through a central portion of the blade 76. A spring-support finger 88 is formed in the blade 76 and extends from within a well 90 in a direction opposite the direction of the nib 78, slightly inboard of the trailing end 80. Another hole 92 is formed through the blade 76 and is located between the nib 78 and the finger 88. Referring to FIG. 10, the drive extension 82 of the blade 76 is formed with a drive hook 94 on a lateral side 96 of the blade.

Referring to FIG. 5, a spring 98 is placed onto the finger 88 and the blade 76 is moved into the first slot 62 of the mandrel 50 so that the spring moves into the cavity 70 and is compressed to apply a normal clockwise bias, as viewed in FIG. 5, to the blade. A pivot pin 100 is inserted into the opening 68 of the mandrel 50 and the opening 86 of the blade 76 to couple the blade to the mandrel for pivoting movement within the first slot 62. When the blade 76 is in the position shown in FIG. 5, the drive extension 82 is extended through the second slot 66 (FIG. 8) under the biasing action of the spring 98.

As shown in FIG. 5, the forward or insertion end of the blade 76 is located within the forward end opening 64 of the mandrel 50 and is positioned so that the forward end face 84 of the blade is, at all times, flush with the forward end face 58 of the mandrel. In this manner, the forward end of the blade 76 is always at the forwardmost location of the tool 48. In addition, the drive hook 94 of the blade 76 extends inward from the forward end face 58 through the thickness of the drive extension 82. Therefore, the drive hook 94 is always at the forwardmost location of the tool 48.

The forward half of the mandrel 50 is located within a sleeve 102 having a plastic spinner 104 attached to a forward end thereof and formed with a flange 106 at a rear end thereof. The sleeve 102 is formed internally in the rear half thereof with an enlargement 108 and a bushing 110 is press fit, or otherwise secured, within the rear end of the enlargement. This arrangement forms a first chamber 112 into which the nib 78 of the blade 76 may be biasingly located as illustrated. It is noted that the sleeve 102 and the bushing 110 could be formed as a single piece without departing from the spirit and scope of the invention.

A cylindrical body 114 is located about the intermediate section 60 of the mandrel 50 and is secured to the mandrel by a pin 116 which is passed through a split opening 118, formed in the body, and the opening 74 in the mandrel. The flange 106 of the sleeve 102 is located for sliding movement relative to the interior of the body 114. A cup-like nut 120 is located about the middle of the intermediate section 60 of the mandrel 50 and is threadedly attached to a forward end of the body 114. A forward wall 122 of the nut 120 and the interior of the body 114 combine to form a second chamber 124 in which the flange 106 of the sleeve 102 is captured. A spring 126 is located within the second chamber 124 and normally urges the sleeve 102 and the bushing 110 in a forward direction. A selected number of washer-like spacers 128 are located within the second chamber 124, and are positioned about the intermediate section 60 of the mandrel 50, to limit the rearward movement of the sleeve 102 and the bushing 110.

In an “at rest” or normal condition when the tool 48 is not being used, the spring 126 biases the flange 106 and the bushing 110 to the forwardmost position whereby the flange engages the inboard side of the forward wall 122 of the nut 120. In this position, the forward end of the sleeve 102 and the spinner 104 essentially cover the threads 56 of the mandrel 50. Also, the bushing 110 is now located in a forward section of the first chamber 112 and has engaged the nib 78 of the blade 76 to move the nib upward, as viewed in FIG. 5, against the biasing action of the spring 98. During the period when the bushing 110 is in engagement with the nib 78, as described above, the blade 76 is pivoted about the pin 100 to retract the drive extension 82 to a position within the first slot 62 of the mandrel 50. In this manner, the drive extension 82 and the drive hook 94 are not unnecessarily exposed during any period when the tool 48 is in the normal condition.

When the tool 48 is to be used, the trailing non-slotted end of the coil insert 26 is threaded onto the forward end of the threads 56 of the mandrel 50 by virtue of the threads 56 and the inner threads 30 of the insert being of the same size. As the insert 26 is threaded onto the forward end of the mandrel 50, the trailing end of the insert engages the forward face of the spinner and urges the sleeve 102 rearward against the biasing action of the spring 126. As the sleeve 102 is being moved rearwardly, the bushing 110 is moved rearward relative to the nib 78 of the blade 76. During this period, the drive extension 82 remains retracted within the first slot 62 because the bushing 110 continues to engage and urge the nib 78 radially inward of the slot 62.

Eventually, as the coil insert is being mounted onto the threaded end of the mandrel 50, the bushing 110 is moved rearward sufficiently to clear the nib 78 whereafter the biasing action of the spring 98 urges the nib in a radially outward direction to pivot the drive extension toward the second slot 66. The drive slot 40 of the coil insert 26 is moved into position to receive the drive hook 94 of the blade 76 in the manner illustrated in FIG. 4. The shank 52 of the “loaded” tool 48 is attached to a power driver 130 to prepare the tool for threadedly inserting the coil insert 26 into the threaded opening 22 of the support structure 20. The power driver 130 could be, for example, an electronic torquesensing driver available from Hios as their Model SB 650C.

The forward end of the tool 48 is positioned at the mouth of the threaded opening 22 of the support structure 20 and the leading end of the coil insert 26 is positioned to threadedly engage the threads 24 of the opening. Thereafter, the power driver 130 is operated and the drive hook 94 is rotated against the wall 42 of the slot 40, formed in the coil insert 26, to literally drive the convolutions of the insert into the helical path formed by the threads 24 of the opening 22. Eventually, the forward face of the spinner 104 engages the support structure 20 which causes the sleeve 102 to move further rearward until the flange 106 engages the lead spacer 128. At this time, the power driver 130 senses the increase torque requirement and reverses the direction of rotation of the mandrel 50 to withdraw the threads 56 from engagement with the threads 30 of the coil insert 26.

The number of spacers 128 to be used, or a single spacer of a given axial length to be used, is directly linked to the axial length of the coil insert 26. For short coil inserts 26, relatively more spacers would be required when compared to the number of spacers required for longer coil inserts.

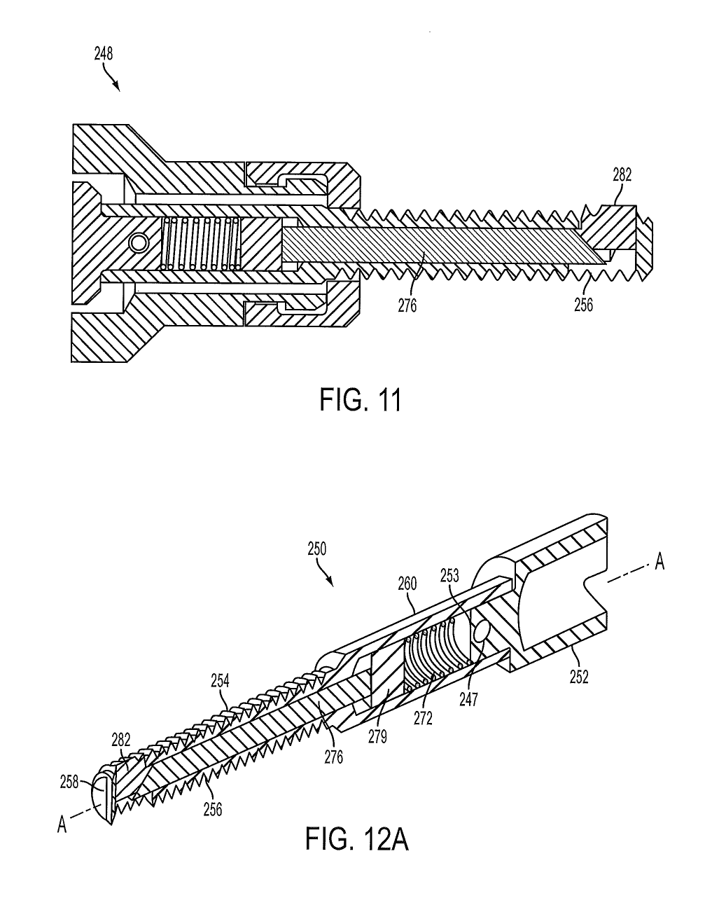

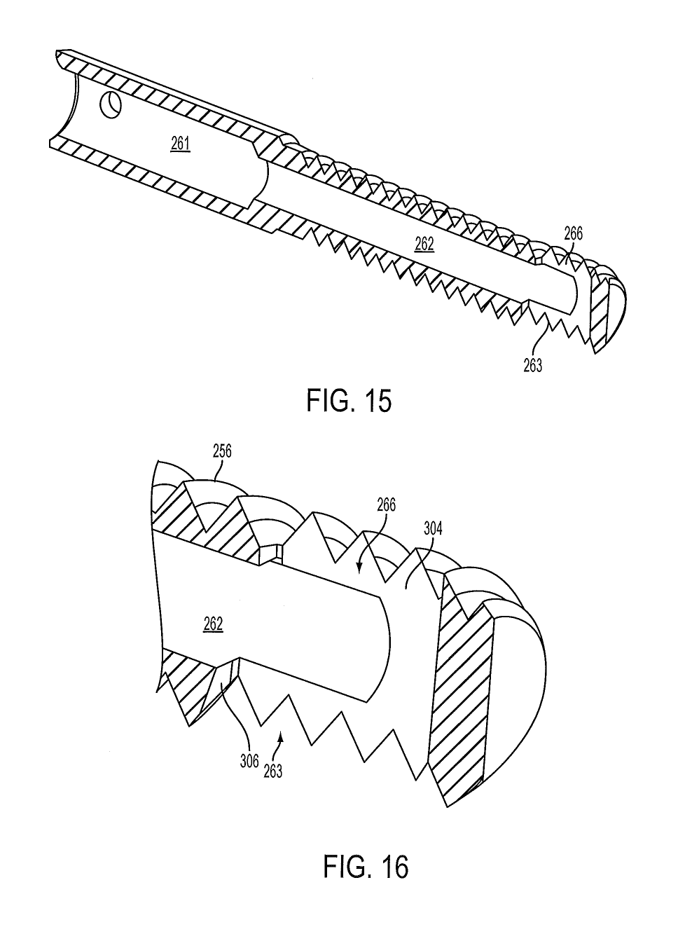

FIGS. 11-18B illustrate the structure of an alternative embodiment to the embodiment of FIG. 5. In this alternate embodiment many elements function in a similar manner as in the embodiment of FIG. 5. However, the invention of FIGS. 11-18B embody some structural differences that will be pointed out below. Applicant appreciates that the alternate embodiment of FIGS. 11-18B may be substituted for various aspects of the embodiment of FIG. 5.

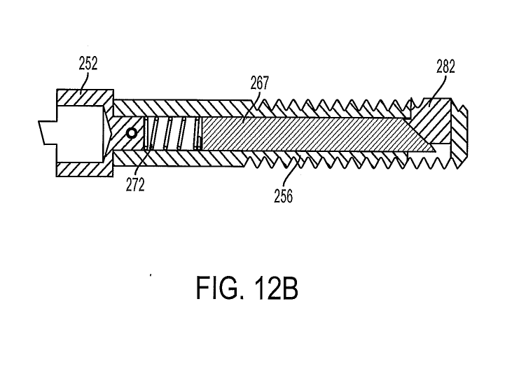

FIGS. 11, 12A, and 12B illustrate the insertion tool 248 of the present invention. The tool 248 includes a rotatable mandrel 250, a biasing member or spring 272, a plunger 276 and a drive projection 282. Rotatable mandrel 250 has a longitudinal axis A-A. The foregoing members work together to selectively extend drive projection 282 from rotatable mandrel 250 in a manner similar to how drive extension 82 is extended from rotatable mandrel 50 in the embodiment of FIG. 5. FIG. 12B illustrates a configuration of the tool in which plunger 276 is of sufficient diameter such that spacer 279 is not needed. In other words, when the desired spring has a diameter larger than the rear cross-sectional surface of plunger 276, spacer 279 may be included to provide an engagement surface of sufficient diameter. Therefore, spacer 279 is of a generally larger diameter than plunger 276.

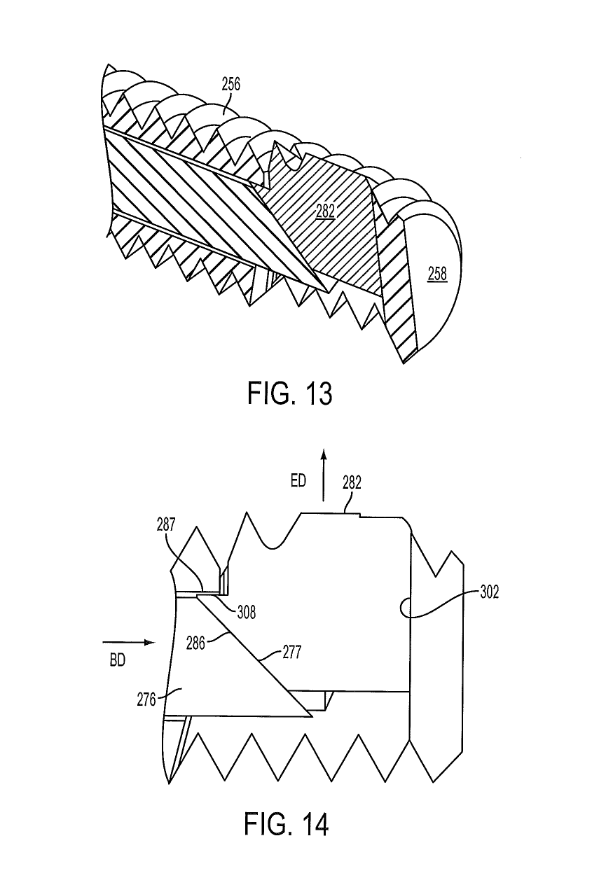

FIGS. 13-16 illustrate a mandrel 250. Like mandrel 50, mandrel 250 a forward extension 254 projects toward the front and the mandrel can be driven from the rear by a drill or some similar hand or power tool. The forward extension 254 of the mandrel 250 is formed with threads 256 externally thereof which are the same size as the inner threads 30 of the coil insert 26. The forward extension 254 is also formed with a forward end face 258 which is the forwardmost surface of the mandrel 250. An intermediate section 260 of the mandrel 250 extends between a drive portion 252 and the forward extension 254, and is formed generally with a circular cross section. Intermediate section 260 can have an increased diameter portion relative to forward extension 256.

Mandrel 250 further includes a forward passage 262 and a rearward passage 261 within which plunger 276 is disposed when assembly. As intermediate section 260 has an increased diameter relative to forward extension 254, rearward passage 261 also defines a larger diameter passageway than forward passage 262. At a forward end of forward extension 254 is a projection slot 266 through which drive projection 282 extends. On mandrel 250, opposite from projection slot 266 is assembly slot 263.

Referring to FIG. 16, mandrel 250 includes a side wall 304. An opposite mirror image side wall (not shown) of side wall 304 along with side wall 304 sandwiches drive projection 282 to direct its travel path within projection slots 266 and 263. In addition, mandrel 250 includes a front wall 302 and an opposite rear wall 306 against which and within which drive projection 282 slidably travels within projection slots 266 and 263. Walls 302, 304, and 306 define restrict drive projection 282 to a travel path that is generally perpendicular to the longitudinal axis A-A of mandrel 250. Furthermore, a stop portion 308 of forward passage 262 serves as a stop that limits or prevents outward or radial projecting of drive projection 282 through projection slot 266. The walls defining the passage within which drive projection 282 travels may be of any form (e.g., flat, cylindrical, etc.) so long as they complement the outer shape of drive projection 282 and slidably define its path.

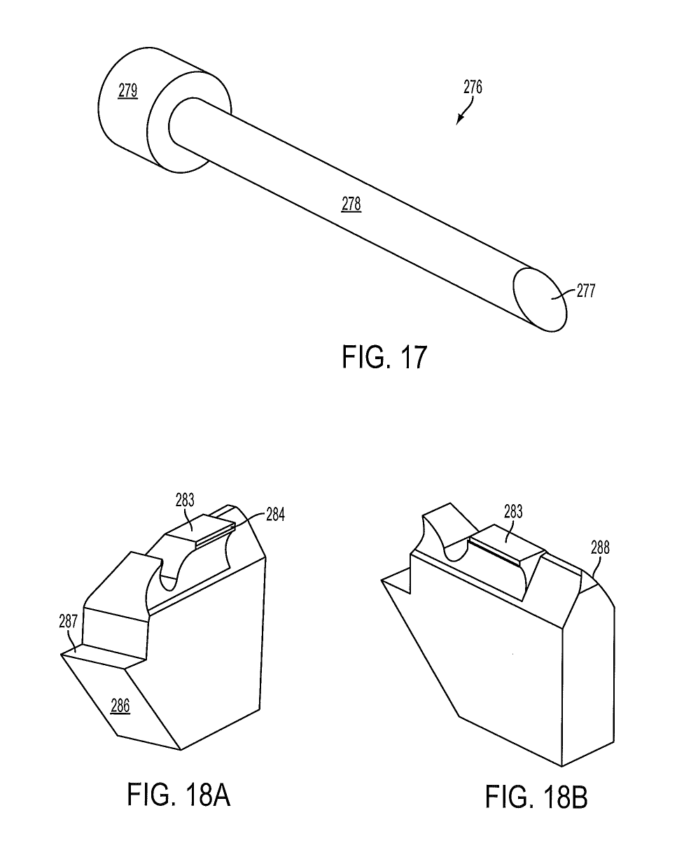

FIG. 17 shows a front perspective view of plunger 276. Plunger 276 includes a cylindrical forward portion 278 of a predetermined diameter and a cylindrical rearward portion or spacer 279 of a diameter larger than the diameter of cylindrical forward portion 278. Spacer 279 may be secured to or separated from cylindrical forward portion 278 and various longitudinal lengths of spacer 279 may be substituted to adjust the forces and operation among the moving parts of the tool. As shown in FIG. 12B, when assembled, plunger 276 is disposed in rotatable mandrel 250 such that cylindrical rearward portion is received in rearward passage 261 and cylindrical forward portion 278 is received in forward passage 262. Plunger 276 is therefore coaxial with forward and rearward passages 261, 262 upon assembly. Forward and rearward passages 261 and 262 receive plunger 276 in a slidable manner such that plunger 276 may translate along longitudinal axis A-A of rotatable mandrel 250. Forward portion 278 includes an inclined surface 277 on a forwardmost portion thereof for slidingly contacting other elements. Plunger portions 278 and 279 need not be cylindrical and can be any suitable cross-sectional shape (e.g., polygonal).

A bias member or spring member 272 is disposed in rearward passage 261 rearward of rearward portion 279. Drive portion 252 is connected to a rear portion of intermediate section 260 (e.g., via a threaded fastener or pin 247). Drive portion 252 also includes a shoulder or stop 253. Spring member 272 is preloaded or pre-compressed against stop 253 as its rear boundary and against rearward portion 279 as its forward boundary.

During assembly, drive projection 282 is inserted into assembly slot 263. Forward portion 278 and spacer 279 are then inserted into rearward passage 261 until inclined surface 277 engages inclined surface 286. Bias member 272 is then inserted into rearward passage 261 before drive portion 252 is pinned to intermediate section 260. In an alternative embodiment, the biasing member may be compressibly aligned with the direction of travel of the drive projection 282. In this alternate embodiment, the bias member may be positioned below drive projection 282 where assembly slot 263 is located.’

FIGS. 18A-18B show various perspective views of drive projection 282. Specifically, FIGS. 18A and 18B show an inclined surface 286 and a projection shoulder or projection stop 287. A drive hook 283 which operates in a similar manner to drive hook 94 of the FIG. 5 embodiment, extends from a top of drive projection 282. An engagement edge 284 of drive hook 283 extends along a line that is parallel to longitudinal axis A-A and remains parallel thereto during operation.

FIGS. 13 and 14 show drive projection 282 in an assembled state. To assemble insertion tool 247, plunger 276 is inserted into forward portion 262 followed by spring member 272. Drive portion 252 is then assembled onto the rear end of intermediate section 260 and pinned thereto by pin 247. When assembled, spring member 272 is pre-compressed so that moving plunger 276 rearward requires a force sufficient to overcome the biasing force of spring member 272.

As shown in FIGS. 12 and 14 drive projection 282 is installed by inserting drive projection 282 (top first) through assembly slot 263. Plunger 276 is then inserted into forward passage 262 to its normal frontward biased position shown in FIGS. 13 and 14. Spacer 279 (if necessary) is then inserted into rearward passage 161 followed by bias member 272. A front portion of drive portion 252 is then inserted into rearward passage 161 and pinned to intermediate section 260 via pin 247. As plunger 276 is biased forward in a biased direction BD by bias member 272, its inclined surface 277 slidingly engages inclined surface 286 of drive projection 282 to force drive projection 282 in an upward or engagement direction ED. Drive projection 282 stops moving in direction ED and comes to rest when projection stop 287 engages an inner wall 308 of forward portion 262. In this rest position, engagement edge 284 extends through projection slot 266 and beyond a periphery of threads 256 and remains parallel to longitudinal axis A-A.

In operation, the tool works similarly as described above with respect to the embodiment of FIG. 5. FIG. 18B shows how a front edge 288 of drive projection 282 is slanted to encourage compliance as insertion tool 247 is inserted into a coil insert 26 to be installed. Because drive hook 283 and guide edge 284 maintains a parallel relationship with longitudinal axis A-A, drive hook 283 also remains parallel with respect to interior thread surfaces 30 as drive hook 283 engages interior surfaces 30 during insertion and extraction of mandrel 250. Wear engagement between drive hook 283 and interior surfaces 30 are general parallel and therefore generally even. Such parallel frictional engagement causes generally uniform wear which minimizes the type of uneven wear that compromises effective engagement between drive hook 283 and the coil drive slot 40.

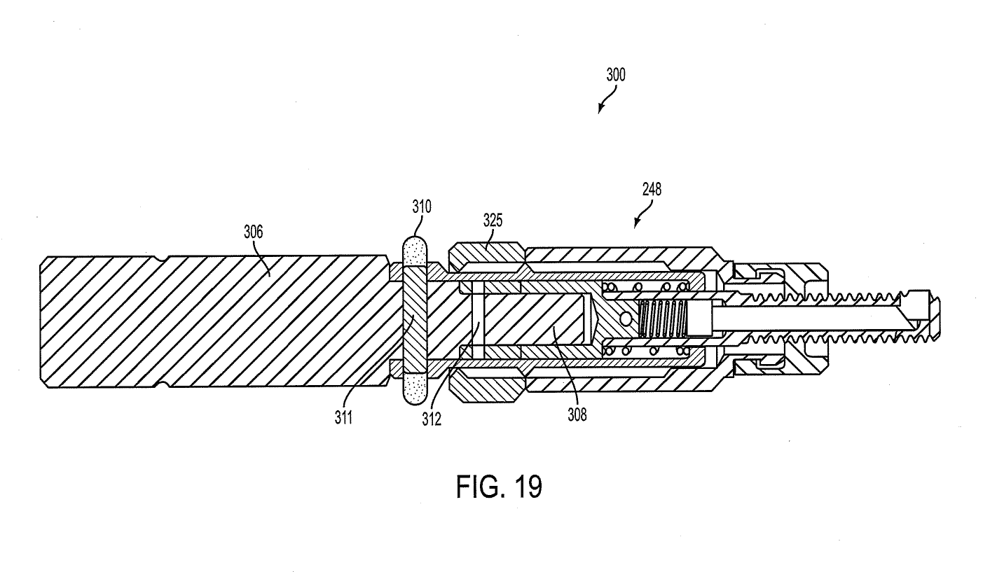

FIG. 19 shows an additional embodiment of the insertion tool 248. A drive assembly 300 includes an insertion tool 248 connected to a driver 306 (e.g., a hex driver for receipt in a hex socket of a hand or power tool for driving the insertion tool). The hex driver could have any cross sectional shape including square or star shape that matches a corresponding driver socket. Driver 306 includes a drive extension 308 that extends through rear clutch part 252B and into forward clutch part 252A. Drive extension 308 has an outer diameter or outer surface that is slightly smaller and corresponding with an inner diameter or inner surface of drive portion 252 of mandrel 250. The connection between the insertion tool 248 and driver 306 can be a pin 311 which allows transfer of torque from drive bit 306 to the insertion tool. In addition, a pin 312 facilitates torque transfer between drive extension 308 and drive portion 252 of mandrel 250. Furthermore, pin 311 can be removed which will allow mandrel 250 to be removed from the rear of housing 301. Mandrel 250, which shows a coil installer of the tangless type, may also be replaced by a mandrel (not shown) which has a well known tanged installer.

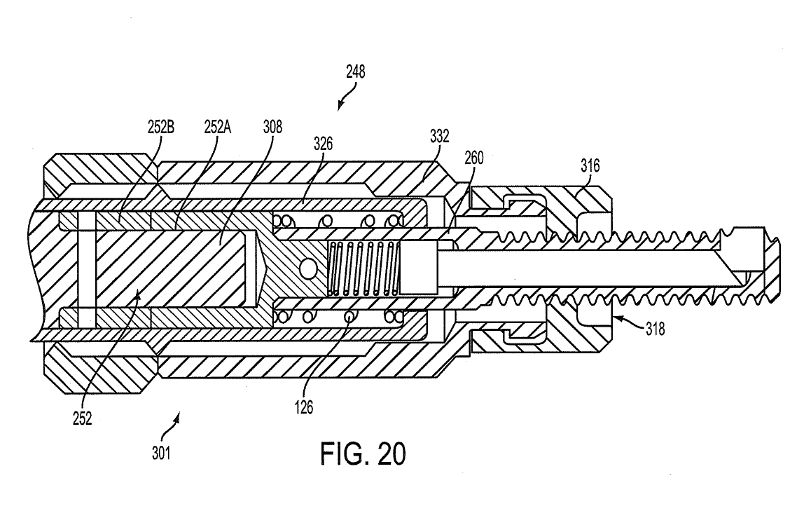

FIG. 20 shows an enlarged view of the insertion tool portion 248 of the drive assembly 300. The insertion tool 240 includes a housing 301 and a mandrel 250. Housing 301 surrounds mandrel 250 and includes a nose or spinner 316, a cylinder 326, and an outer cylinder 332 housing 301. Outer cylinder 332 includes an inner thread and cylinder 326 includes an outer thread. Those inner and outer threads engage to allow outer cylinder 332 and nose 316 to translate relative to each other when outer cylinder 332 is rotated relative to cylinder 326 about the longitudinal axis of the tool. Nose piece 316 can then be adjusted via outer cylinder 332 to adjust the maximum depth to which the coil can be inserted into the workpiece. After the outer cylinder 332 and nose 316 are adjusted, a locking nut 325 which is similarly threaded onto cylinder 326 is adjusted axially against outer cylinder 332 to lock it in an axial depth selection position. Nose 316 includes a pocket or support receptacle 318 (discussed further below). The pin assembly that includes pin 311 includes openings in cylinder 326 and drive member 306. Pin 311 is inserted into both openings as shown and an o-ring 310 is disposed over the openings to prevent removal of pin 311 until desired.

As discussed above, mandrel 250 includes drive portion 252, intermediate section 260, forward extension 254, and drive projection 282. Mandrel 250 may rotate in space or rotate relative to housing 301. Furthermore, during operation, mandrel 250 is able to translate relative to housing 301 against the compression force of a clutch spring or spring 126. In other words, forward extension 254 is able to extend outward from and relative to nose 316 against the force of spring 126.

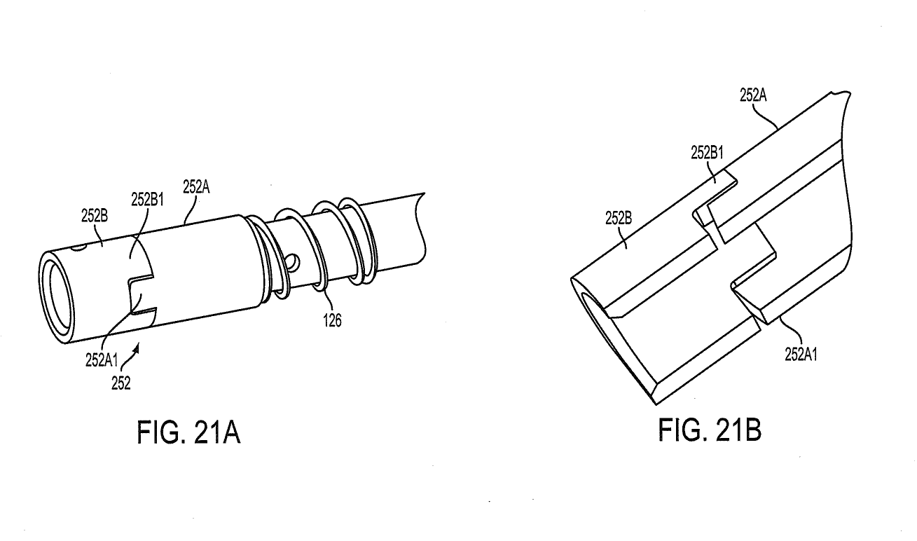

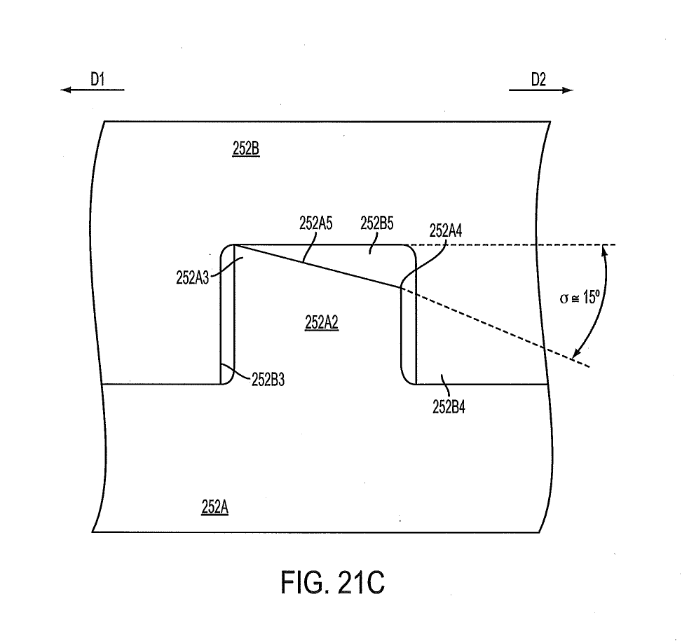

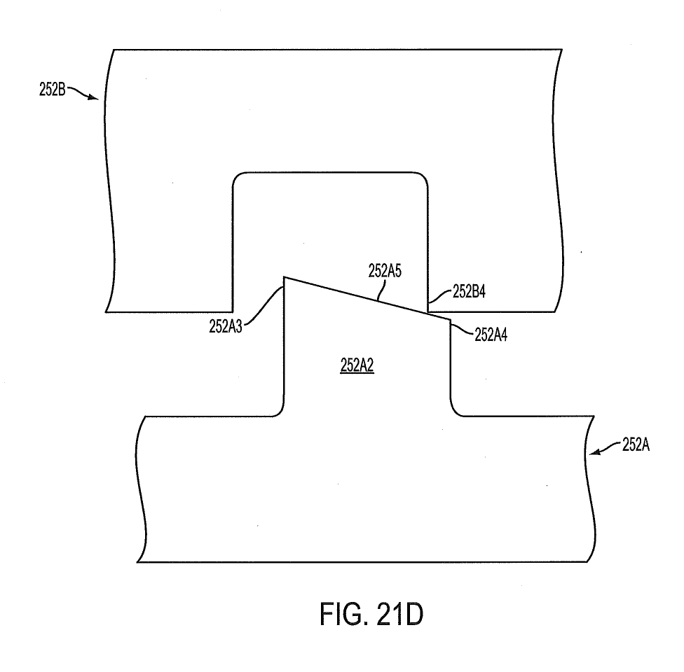

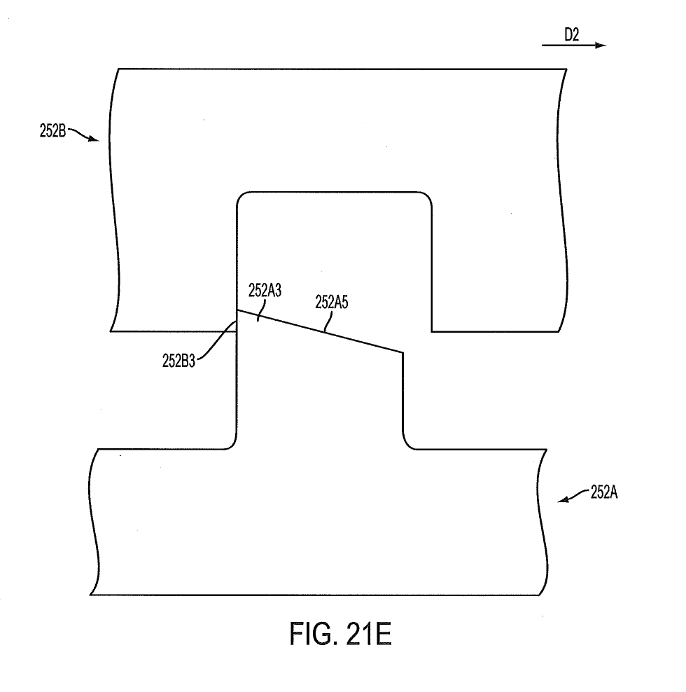

Intermediate section 260 of mandrel 250 is pinned to drive portion 252. Drive portion 252 includes a forward clutch part 252A which is axially aligned with and separable from a rearward clutch part 252B. In addition, forward clutch part 252A includes a first clutch interface 252A1 and rearward clutch part 252B includes a second clutch interface 252B1. Forward clutch part 252A and rearward clutch part 252B interlock at a clutch surface defined by first and second clutch interfaces 252A1 and 252B1 respectively. As shown in FIG. 21C, second clutch interface includes a recess 252B5 having a forward edge 252B3 and another forward edge 252B4. On the other hand, first clutch interface 252A1 includes a projection 252A2 having a rearward edge 252A3 and a forward edge 252A4.

Specifically, first clutch interface 252A extends rearwardly from forward clutch part 252A and axially overlaps second clutch part 252B which extends forward from rearward clutch part 252B. When the axial displacement between forward clutch part 252A and rearward clutch part 252B is great enough so that first and second clutch interfaces no longer overlap, rearward clutch part 252B would be unable to transfer torque to forward clutch part 252A. Therefore, in a range of axial separation distances between rearward clutch part 252B and forward clutch part 252A, rearward clutch part 252B is able to transfer torque to forward clutch part 252A. Outside of that axial separation range no torque will be transferred.

In operation, a user places a replacement coil onto the end of forward extension 254. Drive projection 282 is positioned in the drive slot of the coil to be installed. A rear end of the coil extends into and is surrounded by an opening or pocket 318 in nose 316. Pocket 318 supports or pilots and outer end portion of the coil to be installed and secures it in axial alignment with the longitudinal axis of the tool and the threaded workpiece hole. Maintaining the alignment of the coil increases the ease and effectiveness of the installation.

After aligning the coil, the user rotates driver 306 and thus the drive assembly 300 by hand, by hand tool, or by power tool. Specifically, as torque is applied to driver 306, driver 306 applies torque to rear clutch part 252B via pin 312. Rear clutch part 252B then transfers torque to forward clutch part 252A which in turn transfers torque to intermediate portion 260 of mandrel 250 via pin 247. From there torque is transferred through forward extension 254 to drive projection 282 and then to the coil via the coil drive slot. As the coil is rotated into the workpiece threads, the coil advances forward with respect to the threads. As the coil advances forward the entire drive assembly advances forward with respect to the workpiece. As the coil advances, nose 316 will eventually contact the workpiece. After nose 316 contacts the workpiece, any further rotation of the coil will result in a further forward advance into the workpiece thread and a translation of mandrel 250 relative to nose 316 of housing 301. Such forward translation of the mandrel will be against the biasing force of spring 126 and will result in a proportional amount of separation between forward and rearward clutch parts 252A and 252B. During clutch part separation, drive extension 308 pilot and slides within forward drive portion 252A and ensures that mandrel 250 translates in line with the drive assembly longitudinal axis. With further rotation of the mandrel and coil, additional relative axial displacement will result until first and second clutch interfaces 252A1 and 252B1 no longer overlap axially and no torque is able to be transferred from rearward clutch part 252B to forward clutch part 252A.

Specifically, as forward clutch portion 252A translates relative to rearward clutch portion 252B, eventually forward edge 252A4 will pass forward edge 252B4 so that forward edge 252B4 will engage inclined surface 252A5. The force of 252B4 on inclined surface 252A5 will have a sufficient forward axial component such that rotation of rear clutch part 252B in a D1 direction will compress spring 126. A click or clicks may be heard as spring 126 recompresses the clutch parts. The angle theta shown in FIG. 21C is about 15 degrees or sufficiently low that spring compression will occur before rotation of forward clutch part 252A will occur. In any case, if a higher angle still produces this result, a higher angle may be utilized.

At this point, the mandrel 250 will no longer rotate relative to housing 301 and no further translation of mandrel 250 relative to nose 316 will occur. The decoupling or inclined slipping of the clutch parts as described above prevents over insertion and/or over torque of the coil into the workpiece.

If it is desired to reverse direction of the driver (i.e., D2 opposite the D1 direction), rearward edge 252A3 will engage wall 252B3 to rotate forward clutch portion 252A and mandrel 250 in direction D2 as mandrel 250 translates rearward.

In general, the above-identified embodiments are not to be construed as limiting the breadth of the present invention. Modifications, and other alternative constructions, will be apparent which are within the spirit and scope of the invention as defined in the appended claims.

1. An insertion tool drive assembly for inserting a threaded insert within a threaded opening of a support structure comprising:
a rotatable mandrel having a mandrel insertion end and a driven end located at opposite ends of a longitudinal axis of the mandrel;
a cylinder for slidably receiving the driven end of the mandrel in an axial direction, the driven end of the mandrel including a drive portion and the drive portion further including a forward clutch portion and a rearward clutch portion,
a spring for biasing the driven portion in a rearward direction relative to the cylinder.

2. The insert tool of claim 13, further including a nose piece that is axially adjustable relative to the cylinder for adjusting the depth of the insert.

3. The insert tool of claim 14, wherein the axial adjustment is a threaded adjustment.

4. The insert of claim 13, wherein during installation, the forward clutch portion separates from the rearward clutch portion to prevent further torque transmission between the drive end and the driven end.

5. The insert tool of claim 13, wherein during installation of the threaded insert, the nose piece contacts the support structure and thereafter, further insertion causes forward clutch portion to separate axially from rearward clutch portion against the force of the spring.
